(19) United States
(12) Patent Application Publication
(10) Pub. No.: US 2022/0282009 A1
(43) Pub. Date: Sep. 8, 2022

(54) WIRING HARNESS, WIRING HARNESS MANUFACTURING METHOD, PHOTOCURABLE COMPOSITION AND CURED PRODUCT OF SAME

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shintaro NAMBARA, Mie (JP); Takashi TAKADA, Mie (JP)

(21) Appl. No.: 17/630,635

(22) PCT Filed: Aug. 1, 2019
(86) PCT No.: PCT/JP2019/030173

§ 371 Date: Jan. 27, 2022

(51) Int. Cl. C08F 20/36

(52) U.S. Cl. CPC C08F 20/36

(57) ABSTRACT

It is aimed to provide a wiring harness excellent in the deep curability of a part covered with a water blocking material. In a wiring harness in which an exposed conductor part of an insulated wire is covered with a water blocking material, the water blocking material is a cured product of a photocurable composition containing a photocurable resin and a photopolymerization initiator, and a content of the photopolymerization initiator in the photocurable composition is 0.2 parts by mass or more and 2.0 parts by mass or less based on 100 parts by mass of the photocurable resin.

### TECHNICAL FIELD

The present disclosure relates to a wiring harness in which an exposed conductive part of an insulated wire is covered with a water blocking material, a wiring harness manufacturing method, a photocurable composition suitable as the water blocking material and a cured product of the same.

### BACKGROUND

A wiring harness constituted by a bundle of a plurality of insulated wires may include a spliced portion formed by partially removing coating materials in intermediate or end parts of a plurality of insulated wires and joining exposed conductive parts to each other. This spliced portion needs to be properly waterproofed. The spliced portion is waterproofed by covering the exposed conductive parts of the plurality of insulated wires including the spliced portion with an insulating material. One example of the insulating material used in waterproofing the spliced portion is an ultraviolet curable material. For example, it is described in Patent Document 1 and 2 that a spliced portion is waterproofed by covering exposed conductive parts of a plurality of insulated wires including a spliced portion with an ultraviolet curable material.

### PRIOR ART DOCUMENT

### Patent Document

Patent Document 1: JP 2015-159070 A
Patent Document 2: JP 2015-181322 A

### SUMMARY OF THE INVENTION

### Problems to be Solved

In the case of covering a bundle of exposed conductive parts such as a spliced portion of a wiring harness with a water blocking material, a distance from a center of a conductor bundle to the outer periphery of the water blocking material is in the order of mm if conductor diameters and the like are considered. Thus, a thickness of the water blocking material increases. If this water blocking material is an ultraviolet curable material, there is a problem in the curability of a deep part.

Problems to be solved by present disclosure are to provide a wiring harness excellent in the deep curability of a part covered with a water blocking material, to provide a wiring harness manufacturing method and to provide a photocurable composition suitable as the water blocking material and a cured product of the same.

### Means to Solve the Problem

To solve the above problem, a wiring harness according to the present disclosure is a wiring harness in which an exposed conductor part of an insulated wire is covered with a water blocking material, wherein the water blocking material is a cured product of a photocurable composition containing a photocurable resin and a photopolymerization initiator, and a content of the photopolymerization initiator in the photocurable composition is 0.2 parts by mass or more and 2.0 parts by mass or less based on 100 parts by mass of the photocurable resin.

A photocurable composition according to the present disclosure is used as a water blocking material for blocking a conductor part of an insulated wire from water, and contains a photocurable resin and a photopolymerization initiator, wherein a content of the photopolymerization initiator is 0.2 parts by mass or more and 2.0 parts by mass or less based on 100 parts by mass of the photocurable resin.

A cured product according to the present disclosure is a cured product of the photocurable composition according to the present disclosure.

A wiring harness manufacturing method according to the present disclosure is a manufacturing method for a wiring harness in which an exposed conductor part of an insulated wire is covered with a water blocking material, wherein the water blocking material is formed by covering the exposed conductor part of the insulated wire with the photocurable composition according to the present disclosure and curing the photocurable composition covering the exposed conductor part of the insulated wire.

### Effect of the Invention

The wiring harness according to the present disclosure is excellent in the deep curability of a part covered with the water blocking material. The photocurable composition according to the present disclosure is suitable as the water blocking material and is excellent in deep curability.

### BRIEF DESCRIPTION OF THE DRAWINGS

FIG. 1 is a schematic diagram of a wiring harness according to one embodiment.

FIG. 2 is a section along A-A in FIG. 1.

FIGS. 3A to 3D are process diagrams showing a manufacturing method of the wiring harness shown in FIG. 1.

FIG. 4 is a schematic diagram of a wiring harness according to another embodiment.

FIG. 5 is a schematic diagram of a wiring harness according to still another embodiment.

FIG. 6 is a schematic diagram showing a deep curability evaluation method.

### DETAILED DESCRIPTION TO EXECUTE THE INVENTION

### Description of Embodiments of Present Disclosure

First, embodiments of the present disclosure are listed and described.

(1) The wiring harness according to the present invention is a wiring harness in which an exposed conductor part of an insulated wire is covered with a water blocking material, wherein the water blocking material is a cured product of a photocurable composition containing a photocurable resin and a photopolymerization initiator, and a content of the photopolymerization initiator in the photocurable composition is 0.2 parts by mass or more and 2.0 parts by mass or less based on 100 parts by mass of the photocurable resin. The wiring harness according to the present disclosure is excellent in the deep curability of the part covered with the water blocking material since the content of the photopolymerization initiator in the photocurable composition is 0.2 parts by mass or more and 2.0 parts by mass or less based on 100 parts by mass of the photocurable resin. In this specification, excellent surface curability and deep curability mean that the curing of a surface and a deep part can be completed in less than 10 sec and preferably in less than 5 sec.

(2) The photopolymerization initiator may contain an acylphosphine oxide-based photopolymerization initiator. The acylphosphine oxide-based photopolymerization initiator has an excitation wavelength of 360 nm or more and 410 nm or less. Note that the excitation wavelength means broad rising near 360 nm and broad convergence near 410 nm. Thus, an LED lamp having a center wavelength of 365 nm or more and 395 nm or less can be used as a light source at the time of light irradiation.

(3) The photopolymerization initiator may further contain an alkylphenone-based photopolymerization initiator. This is because the surface curability and deep curability of the photocurable composition are excellent even with a high irradiance of 2000 mW/cm² or more by combining the alkylphenone-based photopolymerization initiator with the acylphosphine oxide-based photopolymerization initiator. The irradiance means an illuminance without attenuation.

(4) The photocurable composition may contain 0.1 part by mass or more and 1.0 part by mass or less of the acylphosphine oxide-based photopolymerization initiator and 0.5 parts by mass or more and 3.0 parts by mass or less of the alkylphenone-based photopolymerization initiator. This is because the surface curability and deep curability of the photocurable composition are excellent even with a low irradiance of 200 mW/cm² or less and with a high irradiance of 2000 mW/cm² or more.

(5) The photocurable resin may contain a urethane (meth)acrylate. This is because the water blocking material is excellent in waterproof performance under a low temperature environment.

(6) The photocurable composition may further contain a (meth)acrylate other than the urethane (meth)acrylate. This is because the water blocking material is excellent in waterproof performance also under a high temperature environment by the photocurable composition containing the urethane (meth)acrylate and the (meth)acrylate other than the urethane (meth)acrylate.

(7) The urethane (meth)acrylate may be a urethane (meth)acrylate having any one of a polyether chain, a polyester chain and a polycarbonate chain. This is because flexible components are easily introduced into a molecular structure and a cured product can be easily made relatively flexible.

(8) A distance from a radial center to a radial outer side of a part covered with the water blocking material may be 3 mm or more. The wiring harness according to the present disclosure is excellent in the deep curability of the part covered with the water blocking material even in such a thick part since the content of the photopolymerization initiator in the photocurable composition is 0.2 parts by mass or more and 2.0 parts by mass or less based on 100 parts by mass of the photocurable resin.

(9) The exposed conductor part of the insulated wire may include a spliced portion formed by joining exposed conductor parts of a plurality of insulated wires to each other. This is because the deep curability of the part covered with the water blocking material is excellent also in the exposed conductor parts of the insulated wires including the spliced portion.

(10) A photocurable composition according to the present disclosure is used as a water blocking material for blocking a conductor part of an insulated wire from water, and contains a photocurable resin and a photopolymerization initiator, wherein a content of the photopolymerization initiator is 0.2 parts by mass or more and 2.0 parts by mass or less based on 100 parts by mass of the photocurable resin. The photocurable composition according to the present disclosure is excellent in deep curability since the content of the photopolymerization initiator is 0.2 parts by mass or more and 2.0 parts by mass or less based on 100 parts by mass of the photocurable resin. The photocurable composition according to the present disclosure can also be used as an anticorrosive besides being used to block the above spliced portion from water. Specifically, the photocurable composition can also be used as an anticorrosive to prevent the intrusion of electrolytes into a joined part of different types of metals such as an aluminum wire and a copper terminal.

(11) The photopolymerization initiator may contain an acylphosphine oxide-based photopolymerization initiator. The acylphosphine oxide-based photopolymerization initiator has an excitation wavelength of 360 nm or more and 410 nm or less. Note that the excitation wavelength means broad rising near 360 nm and broad convergence near 410 nm. Thus, an LED lamp having a center wavelength of 365 nm or more and 395 nm or less can be used as a light source at the time of light irradiation.

(12) The photopolymerization initiator may further contain an alkylphenone-based photopolymerization initiator. This is because the surface curability and deep curability of the photocurable composition are excellent even with a high irradiance of 2000 mW/cm² or more by combining the alkylphenone-based photopolymerization initiator with the acylphosphine oxide-based photopolymerization initiator.

(13) The photocurable composition may contain 0.1 part by mass or more and 1.0 part by mass or less of the acylphosphine oxide-based photopolymerization initiator and 0.5 parts by mass or more and 3.0 parts by mass or less of the alkylphenone-based photopolymerization initiator. This is because the surface curability and deep curability of the photocurable composition are excellent even with a low irradiance of 200 mW/cm² or less and with a high irradiance of 2000 mW/cm² or more.

(14) The photocurable resin may contain a urethane (meth)acrylate. This is because the water blocking material is excellent in waterproof performance under a low temperature environment.

(15) The photocurable composition may further contain a (meth)acrylate other than the urethane (meth)acrylate. This is because the water blocking material is excellent in waterproof performance also under a high temperature environment by the photocurable composition containing the urethane (meth)acrylate and the (meth)acrylate other than the urethane (meth)acrylate.

(16) The urethane (meth)acrylate may be a urethane (meth)acrylate having any one of a polyether chain, a polyester chain and a polycarbonate chain. This is because flexible components are easily introduced into a molecular structure and a cured product can be easily made relatively flexible.

(17) A cured product according to the present disclosure is a cured product of the photocurable composition according to the present disclosure. Deep curability is excellent since the content of the photopolymerization initiator in the photocurable composition according to the present disclosure is 0.2 parts by mass or more and 2.0 parts by mass or less based on 100 parts by mass of the photocurable resin.

(18) A wiring harness manufacturing method according to the present disclosure is a manufacturing method for a wiring harness in which an exposed conductor part of an insulated wire is covered with a water blocking material, wherein the water blocking material is formed by covering the exposed conductor part of the insulated wire with the photocurable composition according to the present disclosure and curing the photocurable composition covering the exposed conductor part of the insulated wire. Deep curability is excellent since the content of the photopolymerization initiator in the photocurable composition according to the present disclosure is 0.2 parts by mass or more and 2.0 parts by mass or less based on 100 parts by mass of the photocurable resin.

(19) In the wiring harness manufacturing method according to the present disclosure, the photocurable composition covering the exposed conductor part of the insulated wire may be cured by irradiating light of 365 nm or more or 395 nm or less. In this case, an LED lamp having a center wavelength of 365 nm or more and 395 nm or less can be used as a light source at the time of light irradiation.

(20) In the wiring harness manufacturing method according to the present disclosure, the photocurable composition covering the exposed conductor part of the insulated wire may be cured with an irradiance of 200 mW/cm² or less. This is because the photocurable composition according to the present disclosure is excellent in surface curability and deep curability even with a low irradiance of 200 mW/cm² or less.

### Details of Embodiments of Present Disclosure

Specific examples of a wiring harness of the present disclosure are described below with reference to the drawings. Note that the present invention is not limited to these illustrations.

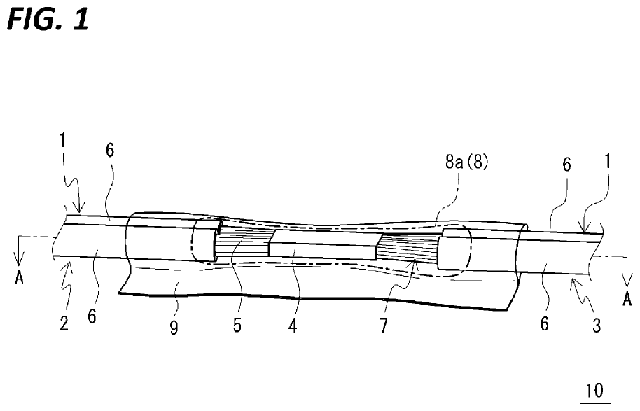

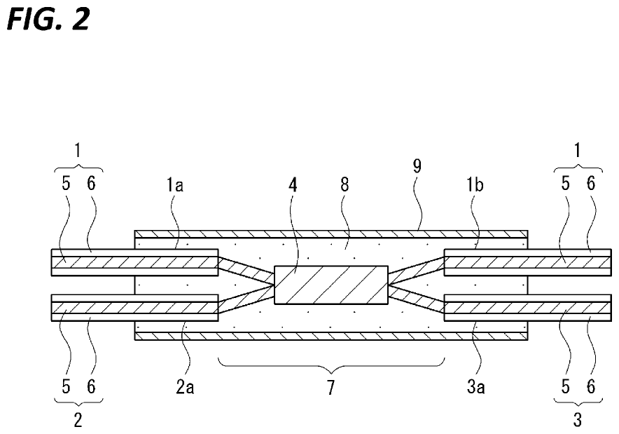

As shown in FIGS. 1 and 2, a wiring harness 10 according to one embodiment is constituted by a wire bundle formed by bundling a plurality of (three) insulated wires 1 to 3. The insulated wire 1 is an insulated wire serving as a main wire, and the insulated wires 2, 3 are insulated wires serving as branch wires to be connected to the insulated wire 1 serving as the main wire in a spliced portion 4. The spliced portion 4 is a spliced portion in an intermediate part of the insulated wire 1 serving as the main wire (intermediate spliced portion).

Each of the insulated wires 1 to 3 is configured such that the outer periphery of a conductor 5 made of a core wire is covered by a coating material 6 made of an insulator. In the insulated wire 1 serving as the main wire, the coating material 6 is partially removed in a longitudinal intermediate part to partially expose the conductor 5 inside. In the insulated wire 2, 3 serving as the branch wire, the coating material 6 is partially removed in a longitudinal end part to partially expose the conductor 5 inside. The spliced portion 4 of the wiring harness 10 is configured by partially removing the coating materials 6 of the respective insulated wires 1 to 3 and joining the conductors 5 of the plurality of insulated wires 1 to 3 in the exposed conductor parts. The conductors 5 may be joined by welding, crimping using crimping terminals or another known joining method.

The wiring harness 10 is configured such that a conductor exposed portion 7 composed of the exposed conductor parts of the plurality of insulated wires 1 to 3 and including the spliced portion 4 and the outer peripheral surfaces of coating material end parts 1a to 3a and 1b of the respective insulated wires 1 to 3 adjacent to the conductor exposed portion 7 are covered by a water blocking material 8. A resin film 9 is arranged outside the water blocking material 8 to cover the outside of the water blocking material 8 in a range wider than the water blocking material 8. By covering the conductor exposed portion 7 with the water blocking material 8 to block water, the intrusion of water into the conductor exposed portion 7 from outside is prevented and a waterproofing effect is obtained.

The water blocking material 8 is constituted by a cured product of a photocurable composition containing a photocurable resin and a photopolymerization initiator.

Examples of the photocurable resin include (meth)acrylates such as (meth)acrylate oligomers and (meth)acrylate monomers. The photocurable resin preferably contains a urethane (meth)acrylate. In the urethane (meth)acrylate, flexible components are easily introduced into a molecular structure. If the photocurable resin contains a urethan (meth)acrylate, the water blocking material 8 is excellent in waterproof performance under a low temperature environment. The photocurable resin may be composed only of urethane (meth)acrylate or may contain a urethane (meth)acrylate and (meth)acrylate(s) other than urethane (meth)acrylate. In the (meth)acrylates other than urethane (meth)acrylate, flexible components are generally less likely to enter a molecular structure except special ones, and cured products of those tend to be relatively hard. Thus, if the photocurable resin contains a urethane (meth)acrylate and (meth)acrylate(s) other than urethane (meth)acrylate, the water blocking material 8 is excellent in waterproof performance also under a high temperature environment. The low temperature environment means a temperature environment of −40° C. or lower. The high temperature environment means a temperature environment of 120° C. or higher.

The urethane (meth)acrylate preferably has a glass transition point of −20° C. or lower when being singly cured. The glass transition point is more preferably −25° C. or lower and further preferably −30° C. or lower. Note that a lower limit value of this glass transition point is not particularly limited, but this glass transition point is preferably −100° C. or higher. The (meth)acrylate other than the urethane (meth)acrylate preferably has a glass transition point of 35° C. or higher when being singly cured. The glass transition point is more preferably 50° C. or higher and further preferably 100° C. or higher. Note that an upper limit value of this glass transition point is not particularly limited, but this glass transition point is preferably 150° C. or lower.

A content of the urethane (meth)acrylate in the entire photocurable resin is preferably 30 mass % or more and 80 mass % or less since the cured product of the photocurable resin is easily made relatively flexible. This content is more preferably 40 mass % or more and 70 mass % or less. In the case of containing the (meth)acrylate other than the urethane (meth)acrylate, a content of the (meth)acrylate other than the urethane (meth)acrylate in the entire photocurable resin is preferably 20 mass % or more and 70 mass % or less since the cured product of the photocurable resin is easily made relatively hard. This content is more preferably 30 mass % or more and 60 mass % or less.

The urethan (meth)acrylate is an oligomer having a urethane bond obtained by the reaction of an isocyanate group and a hydroxy group and a (meth)acryloyl group. By the combination of a polyol and an isocyanate, the urethane (meth)acrylate can be designed from a hard one to a soft one. Since having a (meth)acryloyl group on an end of a molecular chain, the urethane (meth)acrylate can be photocured (ultraviolet cured). The urethane (meth)acrylate is synthesized from a polyol, an isocyanate and a hydroxy group-containing (meth)acrylate.

Urethane (meth)acrylates can be classified by the type of the polyol. A urethane (meth)acrylate containing a polyester polyol as the polyol is a polyester-based urethane (meth)acrylate having a polyester chain in a molecular structure. A urethane (meth)acrylate containing a polyether polyol as the polyol is a polyether-based urethane (meth)acrylate having a polyether chain in a molecular structure. A urethane (meth)acrylate containing a polycarbonate polyol as the polyol is a polycarbonate-based urethane (meth)acrylate having a polycarbonate chain in a molecular structure. A polyester-based urethane (meth)acrylate having a polyester chain in a molecular structure, a polyether-based urethane (meth)acrylate having a polyether chain in a molecular structure and a polycarbonate-based urethane (meth)acrylate having a polycarbonate chain in a molecular structure are preferable as the urethane (meth)acrylate since flexible components are easily introduced into the molecular structure and cured products thereof are easily made relatively flexible.

A polyester polyol used in the synthesis of the urethane (meth)acrylate is obtained from a polybasic organic acid and a low molecular weight polyol, and a polyester polyol having a hydroxyl group as a terminal group can be cited as a preferable one. The polybasic organic acid is not particularly limited, but examples thereof include dicarboxylic acids including saturated fatty acids such as oxalic acids, succinic acids, glutaric acids, adipic acids, pimelic acids, suberic acids, azelaic acids, sebacic acids and isosebacic acids, unsaturated fatty acids such as maleic acids and fumaric acids, and aromatic acids such as phthalic acids, isophthalic acids and terephthalic acids, acid anhydrides such as maleic anhydrides and phthalic anhydrides, dialkyl esters such as dimethyl terephthalate and dimer acids obtained by dimerization of unsaturated fatty acids. The low molecular weight polyol used together with the polybasic organic acid is not particularly limited and examples thereof include diols such as ethylene glycol, diethylene glycol, triethylene glycol, propylene glycol, dipropylene glycol, butylene glycol, neopentyl glycol and 1,6-hexylene glycol, triols such as trimethylol ethane, trimethylol propane, hexanetriol and glycerin, and hexols such as sorbitol. These may be singly used or two or more types of these may be used in combination.

Examples of the polyether polyol used in the synthesis of the urethane (meth)acrylate include polypropylene glycol (PPG), polytetramethylene glycol (PTMG), ethylene oxide modified polyols of these, and polyethylene glycol (PEG). These may be singly used or two or more types of these may be used in combination.

The polycarbonate polyol used in the synthesis of the urethane (meth)acrylate is obtained by polymerizing an alkylene diol as a monomer by a low molecular carbonate compound. Examples of the alkylene diol as the monomer include 1,6-hexane diol, 1,5-pentane diol, 1,4-butane diol and cyclohexane dimethanol. The alkylene diol as the monomer may be one type of these or may be two or more types of these. Examples of the polycarbonate diol include polyhexamethylene carbonate diol, polypentamethylene carbonate diol and polybutylene carbonate diol. These may be singly used or two or more types of these may be used in combination.

Examples of the polyisocyanate used in the synthesis of the urethane (meth)acrylate include diphenyl methane diisocyanate (MDI), polymethylene polyphenylene polyisocyanate (polymeric MDI), crude MDI (c-MDI), which is a mixture of MDI and polymeric MDI, dicyclohexylmethane diisocyanate (hydrogenated MDI), tolylene diisocyanate (TDI), hexamethylene diisocyanate (HDI), trimethyl hexamethylene diisocyanate (TMHDI), isophorone diisocyanate (IPDI), ortho-toluidine diisocyanate (TODI), naphthylene diisocyanate (NDI), xylene diisocyanate (XDI), paraphenylene diisocyanate (PDI), lysine diisocyanate methyl ester (LDI) and dimethyl diisocyanate (DDI). These may be singly used or two or more types of these may be used in combination.

Examples of the hydroxy group-containing (meth)acrylate used in the synthesis of the urethane (meth)acrylate include 2-hydroxyethyl (meth)acrylate, 2-hydroxypropyl (meth)acrylate, and 4-hydroxybutyl (meth)acrylate. These may be singly used or two or more types of these may be used in combination.

Examples of the (meth)acrylates other than the urethane (meth)acrylate include alkyl (meth)acrylate, cycloalkyl (meth)acrylate, alkenyl (meth)acrylate, hydroxyalkyl (meth)acrylate, benzyl (meth)acrylate, polyether (meth)acrylate and polyester (meth)acrylate. The (meth)acrylate other than the urethane (meth)acrylate may be either of a mono(meth)acrylate, which is a monofunctional (meth)acrylate, and a poly(meth)acrylate such as a di(meth)acrylate or tri(meth)acrylate, which is a polyfunctional (meta)acrylate having two or more functions.

Examples of the (meth)acrylates other than the urethane (meth)acrylate, which are classified as mono(meth)acrylates, more specifically include isobornyl (meth)acrylate, bornyl (meth)acrylate, tricyclodecanyl (meth)acrylate, dicyclopentanyl (meth)acrylate, dicyclopentenyl (meth)acrylate, cyclohexyl (meth)acrylate, benzyl (meth)acrylate, 4-butylcyclohexyl (meth)acrylate, 2-hydroxyethyl (meth)acrylate, 2-hydroxypropyl (meth)acrylate, 4-hydroxybutyl (meth)acrylate, methyl (meth)acrylate, ethyl (meth)acrylate, propyl (meth)acrylate, isopropyl (meth)acrylate, octyl (meth)acrylate, isooctyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, isostearyl (meth)acrylate, tetrahydrofurfuryl (meth)acrylate, polyethylene glycol mono(meth)acrylate, polypropylene glycol mono(meth)acrylate, methoxy ethylene glycol (meth)acrylate, ethoxy ethyl (meth)acrylate, methoxy polyethylene glycol (meth)acrylate, methoxy polypropylene glycol (meth)acrylate, and polyoxyethylene nonylphenyl ether acrylate.

Examples of the (meth)acrylates other than urethane (meth)acrylate, which are classified as the poly(meth)acrylates, more specifically include poly(meth) acrylates such as butane diol di(meth)acrylate, hexane diol di(meth)acrylate, nonane diol di(meth)acrylate, decane diol di(meth)acrylate, 2-butyl-2-ethyl-1,3-propane diol di(meth)acrylate, 2-hydroxy-3-acryloyloxy propyl methacrylate, dipropylene glycol di(meth)acrylate, tripropylene glycol di(meth)acrylate, triethylene glycol di(meth)acrylate, tetraethylene glycol di(meth)acrylate, tricyclodecane dimethylol di(meth)acrylate, 1,4-butane polyol di(meth)acrylate, 1,6-hexane polyol di(meth)acrylate, neopentyl glycol di(meth)acrylate, polyethylene glycol di(meth)acrylate, polypropylene glycol di(meth)acrylate, 9,9-bis [4-(2-acryloyl oxyethoxy)phenyl] fluorene, polyester di(meth)acrylate, tris(2-hydroxyethyl) isocyanurate tri(meth)acrylate, tris(2-hydroxyethyl) isocyanurate di(meth)acrylate, tricyclodecane dimethylol di(meth)acrylate, bisphenol A EO-modified di(meth)acrylate, di(meth)acrylate of hydrogenated bisphenol A EO-modified or PO-modified polyol, epoxy (meth)acrylate obtained by adding (meth)acrylate to diglycidyl ether of bisphenol A, triethylene glycol divinyl ether thing, trimethylol propane tri(meth)acrylate, pentaerythritol tri(meth)acrylate, trimethylol propane EO-modified tri(meth)acrylate, pentaerythritol tetra(meth)acrylate, tetrafurfuryl alcohol oligo(meth)acrylate, ethyl carbitol oligo(meth)acrylate, 1,4-butane diol oligo(meth)acrylate, 1,6-hexane diol oligo(meth)acrylate, trimethylol propane oligo(meth)acrylate, pentaerythritol oligo(meth)acrylate and (poly)butadiene (meth)acrylate.

The photopolymerization initiator is a compound for starting the radical polymerization of the photocurable resin by absorbing light such as ultraviolet rays. Examples of the photopolymerization initiator include acylphosphine oxide-based photopolymerization initiators, alkylphenone-based photopolymerization initiators, intramolecular hydrogen extraction-type photopolymerization initiators, oxime ester-based photopolymerization initiators and cation-based photopolymerization initiators. These may be singly used or two or more types of these may be used in combination.

Because of the sizes of conductor diameters, a distance from the outer periphery of the photocurable composition arranged around the conductor exposed portion 7 to the center of the conductor bundle is not in the order of μm, but in the order of mm. In the case of photocuring the photocurable composition arranged around the conductor exposed portion 7, how far light reaches the inside in a depth direction of the photocurable composition arranged around the conductor exposed portion 7 is important with such a thickness. Thus, a content of the photopolymerization initiator in the photocurable composition is set to 2.0 parts by mass or less based on 100 parts by mass of the photocurable resin. Since the content of the photopolymerization initiator is small, the absorption of irradiated light by the photopolymerization initiator located on the surface side of the photocurable composition arranged around the conductor exposed portion 7 is suppressed, the irradiated light easily reaches the inside in the depth direction of the photocurable composition arranged around the conductor exposed portion 7 and the inside in the depth direction can be sufficiently photocured. As just described, if the content of the photopolymerization initiator is relatively small, the surface curability and depth curability of the photocurable composition arranged around the conductor exposed portion 7 are excellent even with a low irradiance of 200 mW/cm² or less and with a high irradiance of 2000 mW/cm² or more. Further, from this perspective, the content of the photopolymerization initiator in the photocurable composition is more preferably 1.0 part by mass or less, even more preferably 0.5 parts by mass or less based on 100 parts by mass of the photocurable resin. On the other hand, from the perspective of ensuring an amount of the photopolymerization initiator sufficient to photocure the photocurable composition arranged around the conductor exposed portion 7, the content of the photopolymerization initiator in the photocurable composition is 0.2 parts by mass or more, more preferably 0.25 parts by mass or more and even more preferably 0.3 parts by mass or more based on 100 parts by mass of the photocurable resin.

A distance from a radial center to a radially outer side of the part of the conductor exposed portion 7 covered with the water blocking material 8 is in the order of mm and preferably 2 mm or more and 6 mm or less, more preferably 3 mm or more and 5 mm or less in consideration of the specific sizes of the conductor diameters.

The photopolymerization initiator preferably contains an acylphosphine oxide-based photopolymerization initiator. The acylphosphine oxide-based photopolymerization initiator has an excitation wavelength of 360 nm or more and 410 nm or less. Note that the excitation wavelength means broad rising near 360 nm and broad convergence near 410 nm. Thus, a light source having a center wavelength of 365 nm or more and 395 nm or less may be used at the time of light irradiation. An LED lamp or the like can be cited as such a light source. The LED lamp is preferable as a light source in terms of power saving.

The photopolymerization initiator may further contain an alkylphenone-based photopolymerization initiator in addition to the acylphosphine oxide-based photopolymerization initiator. The alkylphenone-based photopolymerization initiator has an excitation wavelength near 245 nm, and not in a range of 365 nm or more and 395 nm or less. Thus, if a light source having a center wavelength of 365 nm or more and 395 nm or less is used, the photocurable composition cannot be cured singly with the alkylphenone-based photopolymerization initiator. By combining the alkylphenone-based photopolymerization initiator with the acylphosphine oxide-based photopolymerization initiator, the surface curability and depth curability of the photocurable composition arranged around the conductor exposed portion 7 are excellent even with a low irradiance of 200 mW/cm² or less and with a high irradiance of 2000 mW/cm² or more.

If a light source having a center wavelength of 365 nm or more and 395 nm or less is used in the case of containing the acylphosphine oxide-based photopolymerization initiator and the alkylphenone-based photopolymerization initiator as the photopolymerization initiators, much of the alkylphenone-based photopolymerization initiator having an excitation wavelength outside the range of an irradiation wavelength remains without being decomposed in a cured product after light irradiation. On the other hand, much of the acylphosphine oxide-based photopolymerization initiator having an excitation wavelength in the range of the irradiation wavelength is decomposed in the cured product after light irradiation. Thus, the cured product after light irradiation contains more alkylphenone-based photopolymerization initiator than the acylphosphine oxide-based photopolymerization initiator.

In the case of containing the acylphosphine oxide-based photopolymerization initiator and the alkylphenone-based photopolymerization initiator as the photopolymerization initiators, the photocurable composition preferably contains 0.1 part by mass or more and 1.0 part by mass or less of the acylphosphine oxide-based photopolymerization initiator and 0.5 parts by mass or more and 3.0 parts by mass or less of the alkylphenone-based photopolymerization initiator based on the 100 parts by mass of the photocurable resin.

Examples of the acylphosphine oxide-based photopolymerization initiator include 2,4,6-trimethylbenzoyl diphenylphosphine oxide, bis(2,4,6-trimethylbenzoyl)-phenylphosphine oxide and bis(2,6-dimethoxybenzoyl)-2,4,4-trimethyl-pentylphosphine oxide. Omnirad TPO, Omnirad 819 and the like produced by IGM Resins B.V. can be cited as commercial products.

Examples of the alkylphenone-based photopolymerization initiator include benzyl dimethyl ketal-based photopolymerization initiators such as 2,2-dimethoxy-1,2-diphenylethane-1-one, α-hydroxyalkylphenone-based photopolymerization initiators such as 1-hydroxycyclohexyl-phenyl-ketone, 2-hydroxy-2-methyl-1-phenyl-propane-1-one, 1-[4-(2-hydroxyethoxy)-phenyl]-2-hydroxy-2-methyl-1-propane-1-one and 2-hydroxy-1-{4-[4-(2-hydroxy-2-methyl-propionyl)-benzyl]phenyl}-2-methyl-propane-1-one, and α-aminoacetophenone-based photopolymerization initiators such as 2-methyl-1-[4-(methylthio)phenyl]-2-morpholinopropane-1, 2-benzyl-2-dimethylamino-1-(4-morpholinophenyl)-butane-1-one, 2-(dimethylamino)-2-[(4-methylphenyl)methyl]-1-[4-(4-morpholinyl)phenyl)-1-butanone, and N,N-dimethylamino acetophenone. Omnirad 651 and the like produced by IGM Resins B.V. can be cited as commercial products of the benzyl dimethyl ketal-based photopolymerization initiator. Omnirad 184, Omnirad 1173, Omnirad 2959, Omnirad 127 and the like produced by IGM Resins B.V. can be cited as commercial products of the α-hydroxyalkylphenone-based photopolymerization initiator. Omnirad 907, Omnirad 369, Omnirad 379 and the like produced by IGM Resins B.V. can be cited as commercial products of the α-aminoacetophenone-based photopolymerization initiator.

Omnirad MBF, Ominirad 754 and the like produced by IGM Resins B.V. can be cited as the intramolecular hydrogen extraction photopolymerization initiator. CGI-325, Irgacure OXE01 and Irgacure OXE02 produced by BASF Japan, N-1919 produced by ADEKA and the like can be cited as the oxime ester-based photopolymerization initiator. Omnirad 250, Omnirad 270 and the like produced by IGM Resins B.V. can be cited as the cation-based photopolymerization initiator.

The photocurable composition for constituting the water blocking material 8 may contain an additive.

The resin film 9 holds the photocurable composition around the conductor exposed portion 7 so that the photocurable composition before curing does not flow from the periphery of the conductor exposed portion 7. The resin film 9 may or may not be bonded to the outer surface of the water blocking material 8.

The resin film 9 has optical transparency so that the photocurable composition arranged around the conductor exposed portion 7 can be photocured. That is, irradiation light for photocuring the photocurable composition is allowed to be transmitted to such an extent capable of photocuring. The resin film 9 preferably has an ultraviolet transmittance of 50% or more, more preferably 70% or more and even more preferably 90% or more in terms of giving excellent optical transparency. Further, the resin film 9 is flexible to be deformable, following the deformation of the photocurable composition. In terms of optical transparency and flexibility, a thickness of the resin film 9 is preferably 200 μm or less, more preferably 150 μm or less, further preferably 100 μm or less and even more preferably 5 μm or more and 50 μm or less.

Resin wrap sheets made of olefin-based resins such as polyethylene and polypropylene, polyesters such as polyvinyl chloride, polyvinylidene chloride, polyvinylidene fluoride and polyethylene terephthalate, and polyamides such as nylon can be cited as the resin film 9. Out of these, wrap sheets of polyvinyl chloride resin, polyvinylidene chloride resin and polyvinylidene fluoride resin are preferable in terms of easy winding around the photocurable composition covering around the conductor exposed portion 7.

The resin film 9 may have an adhesive layer on a surface. The resin film 9 having the adhesive layer is preferable since the position thereof is easily fixed when the resin film 9 is wound. In the case of having the adhesive layer, an upper limit value of a thickness of the adhesive layer may be 50 μm or less, 30 μm or less or 20 μm or less.

Although the conductors 5 of the insulated wires 1 to 3 are constituted by stranded wires formed by twisting a plurality of strands, these may be single wires. The conductors 5 may be made of metal excellent in conductivity such as copper, copper alloy, aluminum or aluminum alloy. Metal plating of nickel or the like may be further applied to the metal surface. The coating material 3 may be formed using resin, thermoplastic elastomer, rubber or the like. Polyolefin, PCV and the like can be cited as a material.

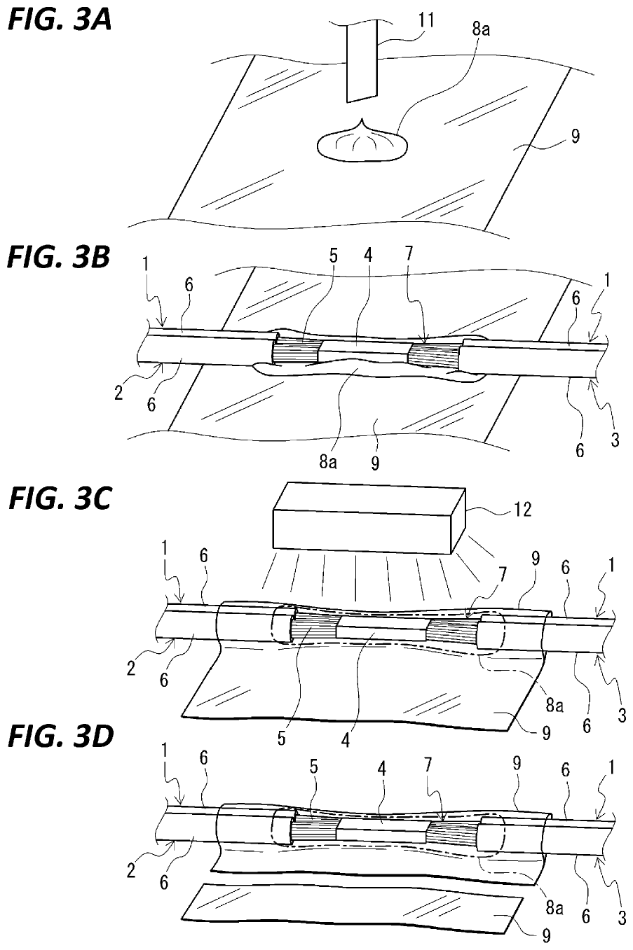

The wiring harness 10 can be manufactured as follows. FIGS. 3A to 3D show a process of a wiring harness manufacturing method.

As shown in FIG. 3A, the spliced portion 4 is formed by partially removing the coating material 6 of each insulated wire 1 to 3 and joining the conductors 5 of the plurality of insulated wires 1 to 3 in the exposed conductor parts. Then, the resin film 9 of a size to cover the conductor exposed portion 7 in a range wider than the conductor exposed portion 7 including the spliced portion 4 is prepared. An adhesive layer containing an adhesive is provided on the surface (inner side surface) of the resin film 9. Subsequently, an amount of a photocurable composition 8a for constituting the water blocking material 8 sufficient to cover the conductor exposed portion 7 is supplied onto the adhesive layer of the resin film 9 from a nozzle 11 of a discharging device. The photocurable composition 8a at the time of discharging may be left at an ambient temperature or may be heated and only have to be in a liquid state.

Subsequently, as shown in FIG. 3B, the conductor exposed portion 7 including the spliced portion 4 is placed on the photocurable composition 8a on the resin film 9.

Subsequently, as shown in FIG. 3C, the resin film 9 is folded to cover upper sides of the conductor exposed portion 7 including the spliced portion 4 and the supplied photocurable composition 8a. End parts of the folded resin film 9 are overlapped outside the conductor exposed portion 7 including the spliced portion 4 in the width direction. The overlapped end parts of the resin film 9 are bonded by the adhesive. At this time, if necessary, the overlapped part of the resin film 9 may be squeezed toward the spliced portion 4. In this way, the photocurable composition 8a can penetrate between and along the wire coatings and a splice diameter can be made constant.

Subsequently, as shown in FIG. 3D, light (ultraviolet rays) is irradiated to the photocurable composition 8a covering the conductor exposed portion 7 through the resin film 9 from a light (ultraviolet) irradiation device 12. An irradiance of the irradiation light may be 50 mW/cm² or more and 10000 mW/cm² or less, preferably 50 mW/cm² or more and 5000 mW/cm² or less. The photocurable composition 8a is photocured to become a cured product, whereby the water blocking material 8 is formed. Subsequently, the overlapped end parts of the resin film 9 are cut if necessary. In the above way, the wiring harness 10 is manufactured.

The photocurable composition 8a for constituting the water blocking material 8 is the above photocurable composition. The photocurable composition contains the photocurable resin and the photopolymerization initiator. The content of the photopolymerization initiator in the photocurable composition is 0.2 parts by mass or more and 2.0 parts by mass or less based on 100 parts by mass of the photocurable resin. In this case, the surface curability and deep curability of the photocurable composition 8a for constituting the water blocking material 8 are excellent even with a low irradiance of 200 mW/cm² or less. Thus, light can be irradiated with a low irradiance of 200 mW/cm² or less. A light irradiation time can be set to be 1 sec or more and 120 sec or less, preferably 1 sec or more and less than 10 sec, and more preferably 1 sec or more and less than 5 sec.

The photocurable composition 8a for constituting the water blocking material 8 can contain an acylphosphine oxide-based photopolymerization initiator as the photopolymerization initiator. Since the acylphosphine oxide-based photopolymerization initiator has an excitation wavelength of 360 nm or more and 410 nm or less, the photocurable composition 8a for constituting the water blocking material 8 can be cured by irradiating light of 365 nm or more and 395 nm or less. Then, a power-saving LED lamp having a center wavelength of 365 nm or more and 395 nm or less can be used as a light source. Note that the excitation wavelength means broad rising near 360 nm and broad convergence near 410 nm.

The photocurable composition 8a for constituting the water blocking material 8 can contain an acylphosphine oxide-based photopolymerization initiator and an alkylphenone-based photopolymerization initiator as the photopolymerization initiators. In this case, since the surface curability and deep curability of the photocurable composition 8a for constituting the water blocking material 8 are excellent even with a high irradiance of 2000 mW/cm² or more, light can be irradiated with a high irradiance of 2000 mW/cm² or more. A light irradiation time can be set to be 1 sec or more and 120 sec or less, preferably 1 sec or more and less than 10 sec, and more preferably 1 sec or more and less than 5 sec.

According to the wiring harness 10 configured as described above, the deep curability of the part covered with the water blocking material 8 is excellent.

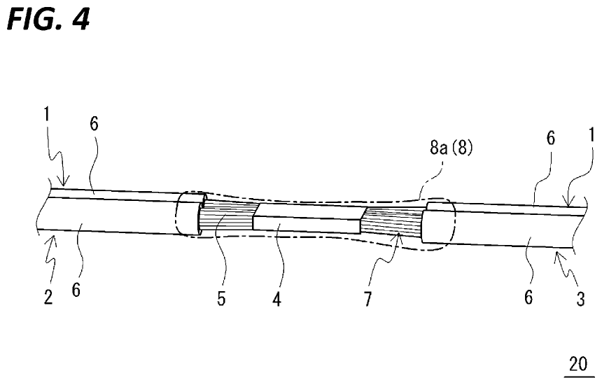

The resin film 9 is used in the wiring harness 10. However, since the photocurable composition 8a is easily applied in a predetermined range, the resin film 9 may not be used if the photocurable composition 8a can be applied in the predetermined range by another method. Further, if adhesion to the cured product of the photocurable composition 8a is low, a wiring harness including no resin film 9 can also be manufactured, such as by removing the resin film 9 after curing. FIG. 4 shows a wiring harness 20 including no resin film 9. The wiring harness 20 is configured similarly to the wiring harness 10 except that the resin film 9 is not provided, and other description is omitted.

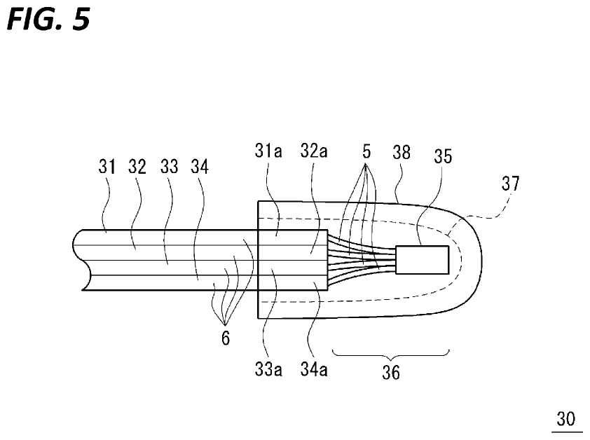

FIG. 5 shows a wiring harness according to still another embodiment. The wiring harness 30 is constituted by a wire bundle formed by bundling a plurality of (four) insulated wires 31 to 34.

Each of the insulated wires 31 to 34 is configured such that the outer periphery of a conductor 5 made of a core wire is covered by a coating material 6 made of an insulator. In each insulated wire 31 to 34, the coating material 6 is partially cut in a longitudinal end part to expose a part of the conductor 5 inside. A spliced portion 35 of the wiring harness 30 is configured by joining the conductors 5 of the plurality of insulated wires 31 to 34 in exposed conductor parts. The conductors 5 may be joined by welding, crimping using crimping terminals or another known joining method. The spliced portion 35 is a spliced portion in end parts of all of the plurality of insulated wires 31 to 34 (end spliced portion).

The wiring harness 30 includes a water blocking material 37 for blocking water by continuously covering a conductor exposed portion 36 formed by a bundle of the exposed conductors of the plurality of insulated wires 31 to 34 and including the spliced portion 35 and the outer peripheral surfaces of coating material end parts 31a to 34a of the respective insulated wires 31 to 34 adjacent to the conductor exposed portion 36. By covering the conductor exposed portion 36 with the water blocking material 37, the intrusion of water into the conductor exposed portion 36 from outside is prevented and a waterproofing effect is obtained. The water blocking material 37 is constituted by a cured material of the above photocurable composition, similarly to the water blocking material 8.

The wiring harness 30 can be manufactured, for example, by filling a photocurable composition into a cap-shaped transparent container 38 having optical transparency to transmit irradiation light for photocuring the photocurable composition to such an extent capable of photocuring, immersing the conductor exposed portion 36 including the spliced portion 35 of the wire bundle and the coating material end parts 31a to 34a of the respective insulated wires 31 to 34 adjacent to the conductor exposed portion 36 in the photocurable composition filled into the transparent container 38 and irradiating light in this state to photocure the photocurable composition. The water blocking material 37 may be removed from the cap-shaped transparent container 38.

### EXAMPLES

The present disclosure is described below by means of examples, but is not limited by the examples.

<Preparation of Photocurable Composition>

Photocurable compositions were prepared by mixing a urethane acrylate oligomer, an acrylate monomer and a photopolymerization initiator in compositions shown in Table 1.

(c-1) Omnirad TPO: 2,4,6-trimethylbenzoyl diphenylphosphine oxide (acylphosphine oxide-based)

(d-1) Omnirad 184: 1-hydroxycyclohexyl-phenyl-ketone (alkylphenone-based)

(Deep Curability)

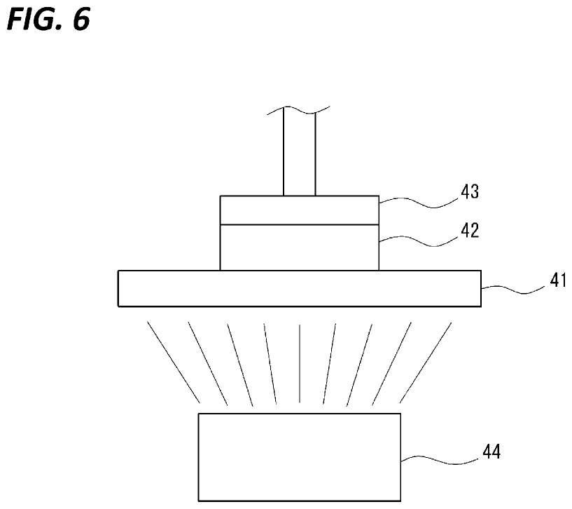

As shown in FIG. 6, a photocurable composition 42 was arranged to have a liquid surface height of 5 mm and a parallel disk-type rheometer (measuring jig (plate 43 having ϕ of 12 mm) of “MCR 102” produced by Anton-Paar) was arranged on the arranged photocurable composition 42. The photocurable composition 42 has a cylindrical shape having the same circle area as the plate 43 having ϕ of 12 mm Subsequently, ultraviolet rays (100 mW/cm²) were irradiated from an LED irradiator 44 (LED-UV lamp) having a center wavelength of 385 nm and arranged below a quartz plate 41. A time until an elastic module starts to increase was set as an irradiation time. The elastic modulus (Pas) in relation to the irradiation time (s) was measured. “A” denotes a case where a curing start time was 5 sec or less, “B” denotes a case where the curing start time was 5 sec or more and 10 sec or less, “C” denotes a case where the curing start time was 10 sec or more and 30 sec or less, and “D” denotes a case where curing was not started even after the elapse of 30 sec.

TABLE 1

| | | | Sample | | | | | | | | | |
|---|---|---|---|---|---|---|---|---|---|---|---|---|
| | | | 1 | 2 | 3 | 4 | 5 | 6 | 7 | 8 | 9 | 10 |
| Composition | Monomer | (a-1) | 60 | 60 | 60 | 45 | 45 | 45 | 60 | 45 | 45 | 60 |
| | Oligomer | (b-1) | 40 | 40 | 40 | — | — | — | 40 | — | — | 40 |
| | | (b-2) | — | — | — | 55 | 55 | 55 | — | 55 | 55 | — |
| | Photopolymerization | (c-1) | 0.2 | 0.5 | 0.9 | 0.2 | 0.5 | 0.9 | 0.1 | 0.1 | 2.5 | 0.2 |
| | Initiator | (d-1) | — | — | — | — | — | — | — | — | — | 1.5 |

| | | | | | | | | | | |
|---|---|---|---|---|---|---|---|---|---|---|
| Deep Curability | A | A | C | A | B | C | D | D | D | A |
| Curing Start Time (sec) | 2 | 5 | 16 | 3 | 6 | 25 | >30 | >30 | >30 | 2 |

(a-1) isobornyl acrylate
(b-1) polycarbonate-based urethane acrylate
(b-2) polyester-based urethane acrylate
(c-1) Omnirad TPO (acylphosphine oxide-based)
(d-1) Omnirad 184 (alkylphenone-based)

According to samples 1 to 10, in a photocurable composition containing a photocurable resin and a photopolymerization initiator, it is understood that the curing of a deep part is started even with a thickness of 5 mm and deep curability is excellent since a content of the photopolymerization initiator is 0.2 parts by mass or more and 2.0 parts by mass or less based on 100 parts by mass of the photocurable resin. If the content of the photopolymerization initiator is less than 0.2 parts by mass based on 100 parts by mass of the photocurable resin, the amount of the photopolymerization initiator is insufficient for photocuring and deep curing did not start with a thickness of 5 mm even when the irradiation time was 30 sec. Further, if the content of the photopolymerization initiator is more than 2.0 parts by mass based on 100 parts by mass of the photocurable resin, an amount of light sufficient for photocuring did not sufficiently reach the deep part with a thickness of 5 mm and deep curing did not start with a thickness of 5 mm even when the irradiation time was 30 sec.

Although the embodiments of the present disclosure have been described in detail above, the present disclosure is not limited to the above embodiments at all and various changes can be made without departing from the gist of the present disclosure.

### LIST OF REFERENCE NUMERALS

1 to 3 insulated wire
1a to 3a, 1b coating material end part
4 spliced portion
5 conductor
6 coating material
7 conductor exposed portion
8 water blocking material
9 resin film
10 wiring harness

1. A wiring harness in which an exposed conductor part of an insulated wire is covered with a water blocking material, wherein:
the water blocking material is a cured product of a photocurable composition containing a photocurable resin and a photopolymerization initiator, and
a content of the photopolymerization initiator in the photocurable composition is 0.2 parts by mass or more and 2.0 parts by mass or less based on 100 parts by mass of the photocurable resin.

2. The wiring harness of claim 1, wherein the photopolymerization initiator contains an acylphosphine oxide-based photopolymerization initiator.

3. The wiring harness of claim 2, wherein the photopolymerization initiator further contains an alkylphenone-based photopolymerization initiator.

4. The wiring harness of claim 3, wherein the photocurable composition contains 0.1 part by mass or more and 1.0 part by mass or less of the acylphosphine oxide-based photopolymerization initiator and 0.5 parts by mass or more and 3.0 parts by mass or less of the alkylphenone-based photopolymerization initiator.

5. The wiring harness of claim 1, wherein the photocurable resin contains a urethane (meth)acrylate.

6. The wiring harness of claim 5, wherein the photocurable composition further contains a (meth)acrylate other than the urethane (meth)acrylate.

7. The wiring harness of claim 5, wherein the urethane (meth)acrylate is a urethane (meth)acrylate having any one of a polyether chain, a polyester chain and a polycarbonate chain.

8. The wiring harness of claim 1, wherein a distance from a radial center to a radial outer side of a part covered with the water blocking material is 3 mm or more.

9. The wiring harness of claim 1, wherein the exposed conductor part of the insulated wire includes a spliced portion formed by joining exposed conductor parts of a plurality of insulated wires to each other.

10. A photocurable composition used as a water blocking material for blocking a conductor part of an insulated wire from water, comprising:
a photocurable resin; and
a photopolymerization initiator,
a content of the photopolymerization initiator being 0.2 parts by mass or more and 2.0 parts by mass or less based on 100 parts by mass of the photocurable resin.

11. The photocurable composition of claim 10, wherein the photopolymerization initiator contains an acylphosphine oxide-based photopolymerization initiator.

12. The photocurable composition of claim 11, wherein the photopolymerization initiator further contains an alkylphenone-based photopolymerization initiator.

13. The photocurable composition of claim 12, wherein the photocurable composition contains 0.1 part by mass or more and 1.0 part by mass or less of the acylphosphine oxide-based photopolymerization initiator and 0.5 parts by mass or more and 3.0 parts by mass or less of the alkylphenone-based photopolymerization initiator.

14. The photocurable composition of claim 10, wherein the photocurable resin contains a urethane (meth)acrylate.

15. The photocurable composition of claim 14, wherein the photocurable composition further contains a (meth)acrylate other than the urethane (meth)acrylate.

16. The photocurable composition of claim 14, wherein the urethane (meth)acrylate is a urethane (meth)acrylate having any one of a polyether chain, a polyester chain and a polycarbonate chain.

17. A cured product of the photocurable composition of claim 10.

18. A wiring harness manufacturing method for a wiring harness in which an exposed conductor part of an insulated wire is covered with a water blocking material, wherein:
the water blocking material is formed by covering the exposed conductor part of the insulated wire with the photocurable composition of claim 10 and curing the photocurable composition covering the exposed conductor part of the insulated wire.

19. The wiring harness manufacturing method of claim 18, wherein the photocurable composition covering the exposed conductor part of the insulated wire is cured by irradiating light of 365 nm or more or 395 nm or less.

20. The wiring harness manufacturing method of claim 18, wherein the photocurable composition covering the exposed conductor part of the insulated wire is cured with an irradiance of 200 mW/cm² or less.
